(19) United States
(12) Patent Application Publication
(10) Pub. No.: US 2025/0254469 A1
(43) Pub. Date: Aug. 7, 2025

(54) MULTI-LAYER ELECTROSTATIC LOUDSPEAKER

(71) Applicant: LAI-SHI HUANG, New Taipei (TW)

(72) Inventor: LAI-SHI HUANG, New Taipei (TW)

(21) Appl. No.: 18/430,800

(22) Filed: Feb. 2, 2024

(51) Int. Cl. H04R 19/02

(52) U.S. Cl. CPC H04R 19/02

(57) ABSTRACT

The multi-layer electrostatic loudspeaker provided by the present invention comprises a case, which accommodates a plurality of pairs of receiving tanks, between every pair of the receiving tanks is a gap; a first electrode layer, which is disposed in the receiving tank of the case; an auxiliary first electrode layer, which is disposed in the receiving tank of the case, wherein the receiving tank is vertically beneath the first electrode layer, a side away from the first electrode layer is disposed a central dielectric layer; and a second electrode layer, which is disposed in the receiving tank of the case, wherein the receiving tank is vertically beneath the first electrode layer.

### BACKGROUND

### Technical Field

The present invention is in related to an electrostatic loudspeaker, more particularly to a multi-layer electrostatic loudspeaker.

### Related Art

General loudspeaker plays sound may be through electric energy converting to magnetic energy, and then to mechanical energy for audiences listening. In practice, according to the working modes of loudspeaker, the categories of loudspeaker are Electric speakers, piezoelectric speakers, electrode (capacitive or electrostatic) speakers, and plasma speakers, with electric speakers being the most common on the market.

With reference to FIG. 1, which illustrates a schematic action view of an electrostatic loudspeaker. Generally speaking, the electrostatic loudspeaker includes: a signal source A1, a transformer A2, a first electrode A3, a second electrode A4, and a vibrating membrane A5. The signal source A1 outputs signals to the first electrode A3 and the second electrode A4 via the transformer A2. The vibrating membrane A5 is polarized through a direct current bias A51, as shown in FIG. 1. The vibrating membrane A5 is a negative electrode, while the signal source A1 causes the first electrode A3 to be a positive electrode, and the second electrode A4 to be a negative electrode. When the vibrating membrane A5 moves towards the first electrode A3, vibrations are generated. The positive and negative electrode conversion of the first electrode A3 and the second electrode A4 is achieved by the signal variations from the signal source A1. Therefore, the vibrating membrane A5 generates vibrations and emits sound.

However, general electrostatic loudspeakers intend to increase the output power by way of stacking. It results in that no potential difference among plural sets of electrostatic loudspeakers causes that of the vibrating membranes A5 between the first electrode A2 and the second electrode A3 being not moved, so that the vibrations of the vibrating membranes A5 can't be generated.

Therefore, how to overcome the practical problem of stacking electrostatic speakers and leading to a situation that of no potential difference and vibration, it becomes a very important issue to people skilled in the art.

### SUMMARY

Accordingly, the objective of the present invention is to overcome the disadvantage of stacking electrostatic loudspeakers to cause no potential difference and vibration.

A multi-layer electrostatic loudspeaker comprises that of a first electrode layer, a side of the first electrode layer being disposed a first electrode connecting part that is connected with an auxiliary first electrode layer, another side of the auxiliary first electrode layer connecting with the first electrode connecting part being disposed a central dielectric layer; and a second electrode layer, a side of the second electrode layer being disposed a dielectric layer connecting part that is connected with the central dielectric layer.

In an embodiment, the present invention further has a first stack structure, a side of the first stack structure is disposed a connecting part that is connected with the second electrode layer or the first electrode layer.

In an embodiment, the connecting part of the first stack structure is connected with the second electrode layer, the connecting part of the first stack structure is a second electrode connecting part, the second electrode connecting part of the first stack structure is connected with an auxiliary second electrode layer, another side of the auxiliary second electrode layer of the first stack structure is disposed the other central dielectric layer, the central dielectric layer of the first stack structure is connected with the other first electrode layer of the first stack structure through the other dielectric layer connecting part of the first stack structure.

In an embodiment, the first stack structure is further connected with a second stack structure, the second stack structure is connected with the first electrode layer of the first stack structure via the first electrode layer of the first electrode connecting part, the first electrode connecting part of the second stack structure is connected with the other auxiliary first electrode layer of the second stack structure, another side of the auxiliary first electrode layer of the second stack structure is disposed the other central dielectric layer of the second stack structure, the central dielectric layer is connected with the other second electrode layer of the second stack structure via the other dielectric layer connecting part of the second stack structure.

A connecting part of the first stack structure is connected with the first electrode layer, the connecting part of the first stack structure is a dielectric layer connecting part, the dielectric layer connecting part of the first stack layer is connected with the other central dielectric layer of the first stack layer, another side of the other central dielectric layer of the first stack layer is disposed an auxiliary second electrode layer which belongs to the first stack layer, the auxiliary second electrode layer is connected with the other second electrode layer of the first stack structure through the second electrode connecting part of the first stack structure.

In an embodiment, the first stack structure further has a second stack structure, which is connected with the second electrode layer of the first stack structure via the other dielectric layer connecting part of the second stack structure, the other dielectric layer connecting part of the second stack structure is connected with the other central dielectric layer of the second stack structure, another side of the other central dielectric layer is disposed the other auxiliary first electrode layer of the second stack structure, the other auxiliary first electrode layer of the second stack structure is connected with the other first electrode layer of the second stack structure via the other first electrode connecting part of the second stack structure.

In an embodiment, the present invention comprises a case, which accommodates a plurality of pairs of receiving tanks, between every pair of the receiving tanks is a gap; a first electrode layer, which is disposed in the receiving tank of the case; an auxiliary first electrode layer, which is disposed in the receiving tank of the case, wherein the receiving tank is vertically beneath the first electrode layer, a side away from the first electrode layer is disposed a central dielectric layer; and a second electrode layer, which is disposed in the receiving tank of the case, wherein the receiving tank is vertically beneath the first electrode layer.

The present invention further has a first stack structure, which is disposed in the pair of receiving tanks of the case, wherein the first stack structure is vertically beneath the second electrode layer or vertically beyond the first electrode layer.

In an embodiment, an auxiliary second electrode layer of the first stack structure is connected with a central dielectric layer of the first stack structure, the first stack structure is disposed in the receiving tank that is vertically beneath the second electrode layer, the central dielectric layer away from the first stack structure is disposed the other first electrode layer, wherein the first electrode layer and the auxiliary first electrode layer are connected with the other first electrode layer of the first stack structure, and the second electrode layer is connected with the auxiliary second electrode layer of the first stack structure.

In an embodiment, the first stack structure is further connected with a second stack structure, which is disposed in the receiving tank vertically beneath the stack structure, the other auxiliary first electrode layer of the second stack structure is connected with the other central dielectric layer of the second stack structure, a second electrode layer of the second stack structure is away from the other central dielectric layer.

In an embodiment, the first stack structure is disposed in the receiving tank vertically beyond the first electrode layer, the other central dielectric layer of the first stack structure is connected with an auxiliary second electrode layer of the first stack structure, the second electrode layer of the first stack structure is away from the auxiliary second electrode layer of the first stack structure, the first electrode layer is connected with the auxiliary first electrode layer, the second electrode layer, the other second electrode layer of the first stack structure, and the auxiliary second electrode layer of the first stack structure is electrically connected with each other.

In an embodiment, the first stack structure is further connected with a second stack structure, which is disposed in the receiving tank vertically beyond the first stack structure, the other dielectric layer of the second stack structure is connected with the other auxiliary first electrode layer of the second stack structure, the auxiliary first electrode layer of the second stack structure is away from the first electrode layer of the second stack structure, wherein the first electrode layer, the auxiliary first electrode layer, the other first electrode layer of the second stack structure, and the other auxiliary first electrode layer of the second stack structure are electrically connected with each other, the second electric layer, the other second electric layer of the first stack structure and the auxiliary second electrode layer of the first stack structure is connected with each other.

In an embodiment, the first electrode layer or the second electrode layer has a plurality of holes.

By means of the first electrode connecting part, the dielectric layer connecting part, or the second electrode connecting part, the first electrode layer and the auxiliary first electrode layer, the second electrode layer and the auxiliary second electrode layer, or at least part of the central dielectric layer is connected with, in order to maintain the gaps among the electrode layers and the central dielectric layer; further, based on a stacking sequence, the present invention avoids the situation of no potential difference. Therefore, the first stack structure or the second stack structure can be stacked infinitely, so as to enhance vibration effect.

It should be understood, however, that this summary may not contain all aspects and embodiments of the present disclosure, that this summary is not meant to be limiting or restrictive in any manner, and that the disclosure as disclosed herein will be understood by one of ordinary skill in the art to encompass obvious improvements and modifications thereto.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 illustrates a schematic action view of a conventional electrostatic loudspeaker;

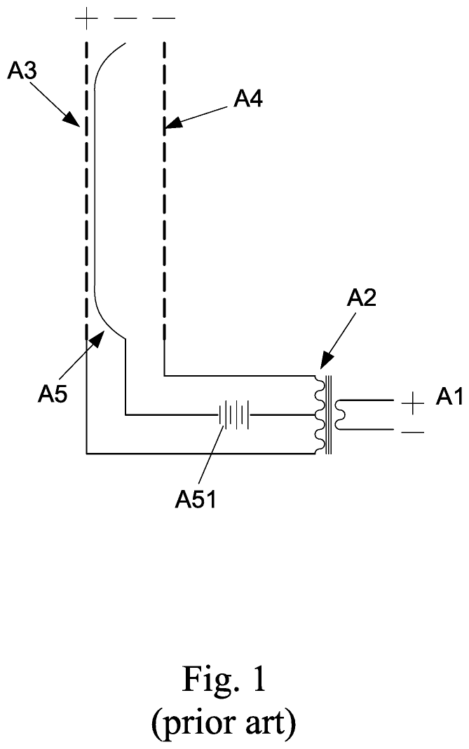

FIG. 2 illustrates a schematic cross-sectional view of a multi-layer electrostatic loudspeaker of the present invention;

FIG. 3 illustrates a schematic cross-sectional view of stacking a first stack structure from a direction of the second electrode layer of the multi-layer electrostatic loudspeaker of the present invention;

FIG. 4 illustrates a schematic cross-sectional view of stacking a second stack structure from the direction of the second electrode layer of the multi-layer electrostatic loudspeaker of the present invention;

FIG. 5 illustrates a schematic cross-sectional view of stacking a first stack structure from the direction of the first electrode layer of the multi-layer electrostatic loudspeaker of the present invention;

FIG. 6 illustrates a schematic cross-sectional view of stacking a second stack structure from the direction of the first electrode layer of the multi-layer electrostatic loudspeaker of the present invention;

FIG. 7 illustrates a schematic cross-sectional view of another embodiment of the multi-layer electrostatic loudspeaker of the present invention;

FIG. 8 illustrates a schematic cross-sectional view of stacking the first stack structure from the direction of the second electrode layer of another embodiment of the multi-layer electrostatic loudspeaker of the present invention;

FIG. 9 illustrates a schematic cross-sectional view of stacking the second stack structure from the direction of the second electrode layer of another embodiment of the multi-layer electrostatic loudspeaker of the present invention;

FIG. 10 illustrates a schematic cross-sectional view of stacking the first stack structure from the direction of the first electrode layer of another embodiment of the multi-layer electrostatic loudspeaker of the present invention; and

FIG. 11 illustrates a schematic cross-sectional view of stacking the second stack structure from the direction of the first electrode layer of another embodiment of the multi-layer electrostatic loudspeaker of the present invention.

### DETAILED DESCRIPTION OF THE EMBODIMENTS

The present disclosure will now be described more fully hereinafter with reference to the accompanying drawings, in which exemplary embodiments of the disclosure are shown. This present disclosure may, however, be embodied in many different forms and should not be construed as limited to the embodiments set forth herein. Rather, these embodiments are provided so that this present disclosure will be thorough and complete, and will fully convey the scope of the present disclosure to those skilled in the art.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substantial/substantially” means, within an acceptable error range, the person skilled in the art may solve the technical problem in a certain error range to achieve the basic technical effect.

The following description is of the best-contemplated mode of carrying out the disclosure. This description is made for the purpose of illustration of the general principles of the disclosure and should not be taken in a limiting sense. The scope of the disclosure is best determined by reference to the appended claims.

Moreover, the terms “include”, “contain”, and any variation thereof are intended to cover a non-exclusive inclusion. Therefore, a process, method, object, or device that includes a series of elements not only includes these elements, but also includes other elements not specified expressly, or may include inherent elements of the process, method, object, or device. If no more limitations are made, an element limited by “include a/an . . . ” does not exclude other same elements existing in the process, the method, the article, or the device which includes the element.

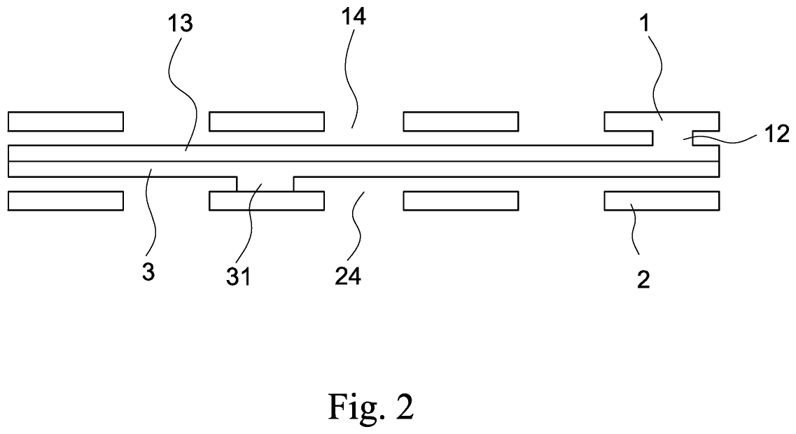

Please refer to FIG. 2, which illustrates a schematic cross-sectional view of a multi-layer electrostatic loudspeaker of the present invention. The multi-layer electrostatic loudspeaker provided by the present invention includes a first electrode layer 1, a second electrode layer 2 and a central dielectric layer 3.

A side of the first electrode layer 1 is disposed a first electrode connecting part 12 that is connected with an auxiliary first electrode layer 13. Another side of the first electrode connecting part 12 is connected with the auxiliary first electrode layer 13. Another side of the auxiliary first electrode layer 13 is disposed a central dielectric layer 3. Physically speaking, each of the first electrode layer 1, the first electrode connecting part 12 and the auxiliary first electrode 13 is disposed an upper lateral surface and a lower lateral surface. The lower lateral surface of the first electrode layer 1 is connected with the upper lateral surface of the first electrode connecting part 12; the lower lateral surface of the first electrode connecting part 12 is connected with the upper lateral surface of the auxiliary first electrode layer 13; and the lower lateral of the auxiliary first electrode layer 13 is connected with the central dielectric layer 3.

A side of the second electrode layer 2 is disposed a dielectric layer connecting part 31 that is connected with the central dielectric layer 3. Particularly, each of the second electrode layer 2, the dielectric layer connecting part 31 and the central dielectric layer 3 has an upper lateral surface and a lower lateral surface. The upper lateral surface of the second electrode layer 2 is connected with the lower lateral surface of the dielectric layer connecting part 31; the upper lateral surface of the dielectric layer connecting part 31 is connected with the lower lateral surface of central dielectric layer 3; and the upper lateral surface of the central dielectric layer 3 is connected with the lower lateral surface of the auxiliary first electrode layer 13.

As to an embodiment, the first electrode layer 1 and the first dielectric layer 11 are simultaneously disposed a plurality of holes 14, and the same applies to the second electrode layer 2 and the second dielectric layer 21.

Via the first electrode connecting part 12 or the dielectric layer connecting part 31, the first electrode layer 1 or the central dielectric layer 3 is connected with at least the partial second electrode layer 2, in order to maintain a gap between those electrode layers and the central dielectric layer 3 for satisfying Coulomb's law. Therefore, the first electrode layer 1, the auxiliary first electrode layer 13 and the second electrode layer 3 are as two electrodes. The central dielectric layer 3 is thus polarized, and by converting the electrode polarity of the first electrode layer 1 and the second electrode layer 2, the present invention achieves an increase in vibration in the central dielectric layer 3. Such vibration is output through the plurality of holes 24 of the first electrode layer 1 and the second electrode layer 2.

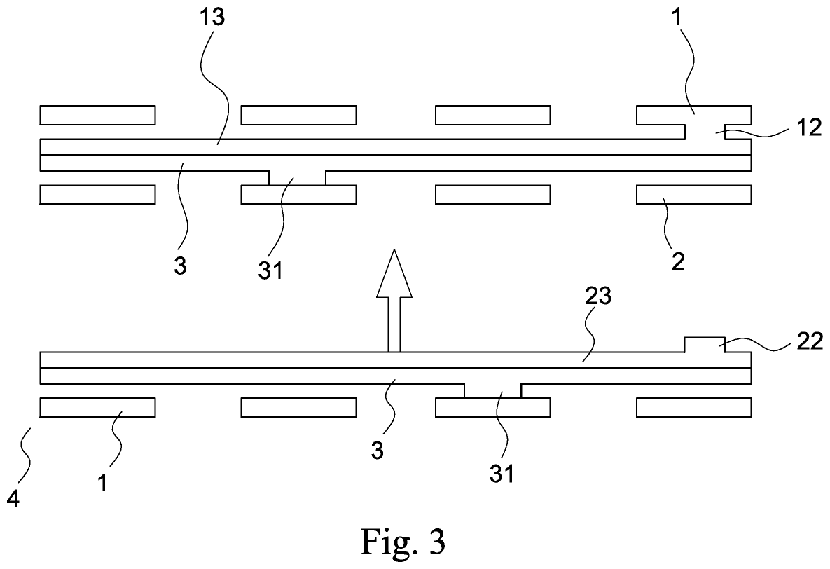

With reference to FIG. 3, which illustrates a schematic cross-sectional view of stacking a first stack structure from a direction of the second electrode layer of the multi-layer electrostatic loudspeaker of the present invention. As to the embodiment, a first stack structure 4 is further disposed. The first stack structure 4 is on the lower lateral surface of the second electrode layer 2, and is connected with an auxiliary second electrode layer 23 through a second electrode connecting part 22. Another side of the auxiliary second electrode layer 23 is set a central dielectric layer 3. Another side of the central dielectric layer 3 of the first stack structure 4 is partially set a dielectric layer connecting part 31. The dielectric layer connecting part 31 of the first stack structure 4 is connected with a first electrode layer 1 of the first stack structure 4. In practice, each of the second electrode connecting part 22 of the first stack structure 4, the auxiliary second electrode layer 23, the central dielectric layer 3, the dielectric layer connecting part 31, and the first electrode layer 1 of the first stack structure 4 has an upper lateral surface and a lower lateral surface. The upper lateral surface of the second electrode connecting part 22 of the first stack structure 4 is connected with the second electrode layer 2; the lower lateral surface of the second electrode connecting part 22 of the first stack structure 4 is connected with the upper lateral surface of the auxiliary second electrode layer 23 of the first stack structure 4; the lower lateral surface of the auxiliary second electrode layer 23 of the first stack structure 4 and the upper lateral surface of the central dielectric layer 3 of the first stack structure 4 are connected with each other. The lower lateral surface of the central dielectric layer 3 of the first stack structure 4 is connected with the upper lateral surface of the dielectric layer connecting part 31 of the first stack structure 4. The lower lateral of the dielectric layer connecting part 31 of the first stack structure 4 and the upper lateral surface of the first electrode layer 1 of the first stack structure 4 are connected with each other.

The embodiment is the connection of the first stack structure 4, and it causes that the second electrode layer 2, the second electrode connecting portion 22 of the first stacked structure 4 and the auxiliary second electrode 23 are connected with each other and have the same polarity. The first electrode layer 1, the first electrode connecting part 12, the auxiliary first electrode layer 13, and the other first electrode layer 1 of the first stack structure 4 have the same polarity. At least part of the second electrode connecting part 22 of the first stack structure 4 is connected with, or the central dielectric layer 3 and the first electrode layer 1 of the first stack structure 4 are partially connected with each other, in order to maintain a gap between those electrode layers and the central dielectric layer 3 for satisfying Coulomb's law. Therefore, the first electrode layer 1, the auxiliary first electrode layer 13 and the first electrode layer 1 of the first stack structure 4 are as one electrode. The second electrode layer 2 and the auxiliary second electrode layer 23 of the first stack structure 4 become another electrode. The central dielectric layer 3 is thus polarized, and stacking and connecting with the first stack structure 4 is to let the present invention achieves an increase in vibration in the central dielectric layer 3.

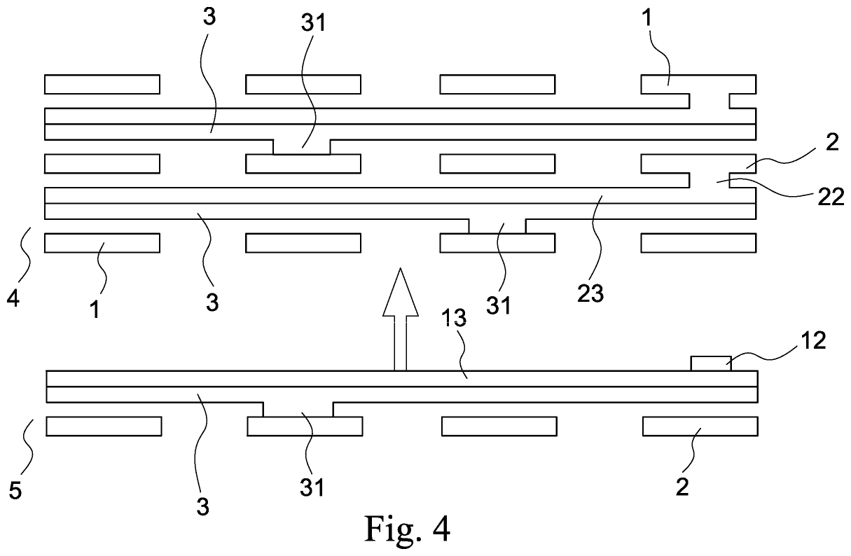

Regarding to FIG. 4, which illustrates a schematic cross-sectional view of stacking a second stack structure from the direction of the second electrode layer of the multi-layer electrostatic loudspeaker of the present invention. As to the embodiment, a second stack structure 5 is further disposed. The second stack structure 5 is disposed on the lower lateral surface of the first stack structure 4; a first electrode connecting part 12 of the second stack structure 5 is connected with the other first electrode layer 1 of the first stack structure 4; another side of the first electrode connecting part 12 of the second stack structure 5 is disposed an auxiliary first electrode layer 13; another side of the auxiliary first electrode layer 13 of the second stack structure 5 is set a central dielectric layer 3; another side of the central dielectric layer 3 of the second stack structure 5 is disposed a dielectric layer connecting part 31; the dielectric layer connecting part 31 of the second stack structure 5 and a second electrode layer 2 are connected with each other. In practice, each of the first electrode connecting part 12, the auxiliary first electrode layer 13, the central dielectric layer 3, and the second electrode layer 2 of the second stack structure 5 has an upper lateral surface and a lower lateral surface. The upper lateral surface of the first electrode connecting part 12 of the second stack structure 5 is connected with the lower lateral surface of the first electrode layer 1 of the first stack structure 4. The upper lateral surface of the auxiliary first electrode layer 13 of the second stack structure 5 is connected with the lower lateral surface of the first electrode connecting part 12 of the second stack structure 5. The lower lateral surface of the auxiliary first electrode layer 13 of the second stack structure 5 is connected with the upper lateral surface of the central dielectric layer 3 of the second stack structure 5. The lower lateral surface of the central dielectric layer 3 of the second stack structure 5 is connected with the upper lateral surface of the dielectric layer connecting part 31 of the second stack structure 5. The lower lateral surface of the dielectric layer connecting part 31 of the second stack structural 5 is connected with the upper lateral surface of the second electrode layer 2 of the second stack structure 5.

The embodiment is further to connect with the second stack structure 5. Hence, the second electrode layer 2, the second electrode connecting part 22 and the auxiliary second electrode layer 23 of the first stack structure 4, and the second electrode layer 2 of the second stack structure 5 have the same polarity. Continuously, the first electrode layer 1, the first electrode connecting part 12, the auxiliary first electrode layer 13, the first electrode layer 1 of the first stack structure 4, the first electrode connecting part 12 and the auxiliary first electrode layer 23 of the second stack structure 5 have the same polarity. At least part of the first electrode connecting part 12 of the second stack structure 5 is connected with the first electrode layer 1 of the first stack structure 4, or the central dielectric layer 3 of the first stack structure 4 and at least part of the first electrode layer 1 are connected with each other, in order to a gap between those electrode layers and the central electrode layer 3 for satisfying Coulomb's law. Therefore, the first electrode layer 1, the auxiliary first electrode layer 13, the first electrode layer 1 of the first stack structure 4, and the auxiliary first electrode layer 13 of the second stack structure 5 are as one electrode. The second electrode layer 2, the auxiliary second electrode layer 23 of the first stack structure 4 and the second electrode layer 2 of the second stack structure 5 become another electrode. The central dielectric layers 3 are thus polarized, and stacking and connecting with the second stack structure 5 and the first stack structure 4 is to let the vibrations of the central dielectric layers 3 be the same, further enhancing the amplification effect.

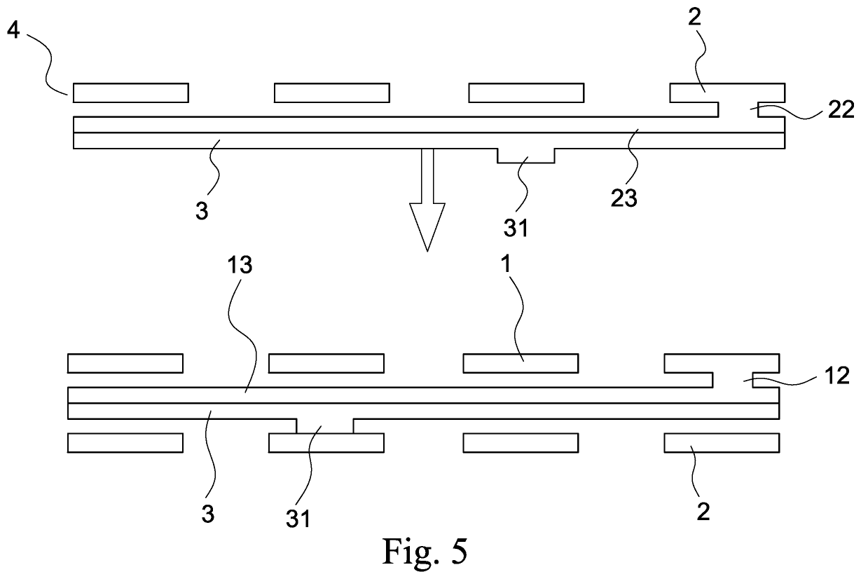

With respect to FIG. 5, which illustrates a schematic cross-sectional view of stacking a first stack structure from the direction of the first electrode layer of the multi-layer electrostatic loudspeaker of the present invention. In the embodiment, the first stack structure 4 is further added, and is disposed on the upper lateral surface of the first electrode layer 1. The first stack structure 4 is connected with the central dielectric layer 3 via the dielectric layer connecting part 31. An auxiliary second electrode layer 23 is provided on the other side of the central dielectric layer 3 of the first stacked structure 4. Another side of the auxiliary second electrode layer 23 of the first stack structure 4 is disposed a second electrode connecting part 22. The second electrode connecting part 22 of the first stack structure 4 and the other second electrode layer 2 of the first stack structure 4 are connected with each other.

For the embodiment, by means of connecting with the first stack structure 4, the second electrode layer 2, the second connecting part 22 and the auxiliary second electrode layer 22 of the first stack structure 4 are connected with each other and have the same polarity. The first electrode layer 1, the first electrode connecting part 12 and the auxiliary first electrode layer 13 have the same polarity. At least part of the second electrode connecting part 22 of the first stack structure 4 is connected with the auxiliary second electrode layer 23, or the dielectric layer connecting part 31 of the first stack structure 4 is connected with part of the first electrode layer 1, in order to maintain a gap between those electrode layers and the central dielectric layer 3 for satisfying Coulomb's law. Therefore, the first electrode layer 1 and the auxiliary first electrode layer 13 are as one electrode. The second electrode layer 2 and the second electrode layer 2 and the auxiliary second electrode layer 23 of the first stack structure 4 become another electrode. The central dielectric layers 3 are thus polarized, and stacking and connecting with the first stack structure 4 is to let the vibrations of the central dielectric layers 3 be the same, further enhancing the amplification effect.

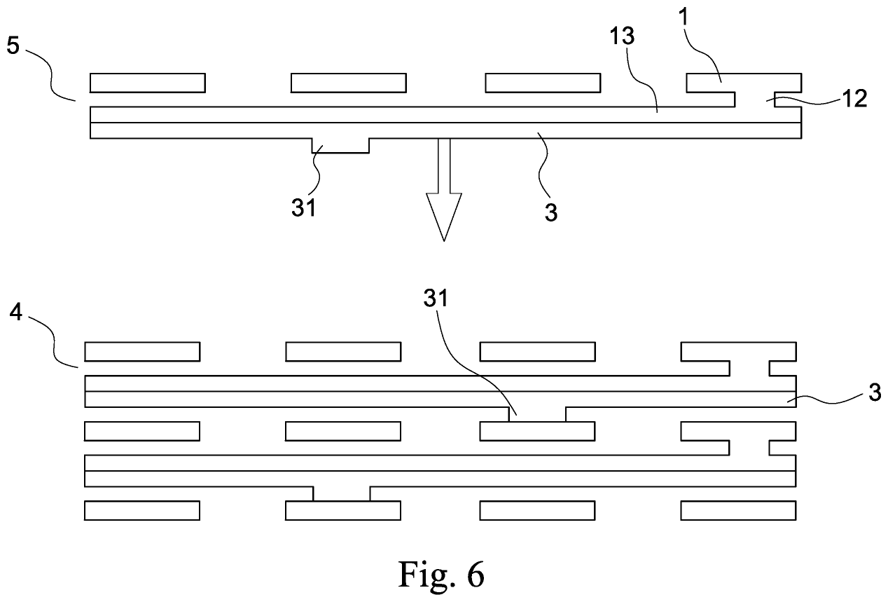

Please refer to FIG. 6, which illustrates a schematic cross-sectional view of stacking a second stack structure from the direction of the first electrode layer of the multi-layer electrostatic loudspeaker of the present invention. For the embodiment, the other second stack structure 5 is further disposed, and is located on the upper lateral surface of the first stack structure 4. A dielectric layer connecting part 31 of the second stack structure 5 is connected with the second electrode layer 2 of the first stack structure 4. Another side of the dielectric layer connecting part 31 of the second stack structure 5 is disposed the other central dielectric layer 3. Another side of the central dielectric layer 3 of the second stack structure 5 is set the other auxiliary first electrode layer 13. The auxiliary first electrode layer 13 of the second stack structure 5 is connected with the first electrode layer 1 through the other first electrode connecting part 12.

The second stack structure 5 is further connected for the embodiment, and it results that the second electrode layer 2 and the second electrode layer 2 and the auxiliary second electrode layer 23 of the first stack structure 4 are connected with each other and have the same polarity. The auxiliary first electrode layer 13, the first electrode layer 1 of the first stack structure 4, the first electrode layer 1 and the auxiliary first electrode layer 13 of the second stack structure 5 have the same polarity. At least part of the dielectric layer connecting part 31 of the second stack structure 5 is connected with the second electrode layer 2 of the first stack structure 4, or the central dielectric layer 3 of the first stack structure 4 is connected with part of the first electrode layer 1, in order to maintain a gap between those electrode layers and the central dielectric layer 3 for satisfying Coulomb's law. Therefore, the first electrode layer 1, the auxiliary first electrode layer 13, the first electrode layer 1 of the second stack structure 5, and the auxiliary first electrode layer 13 are as one electrode. The second electrode layer 2, the auxiliary second electrode layer 23, and the second electrode layer 2 of the first stack structure 4 become another electrode. The central dielectric layers 3 are thus polarized, and stacking and connecting with the first stack structure 4 via the second stack structure 5 is to let the vibrations of the central dielectric layers 3 be the same, further enhancing the amplification effect.

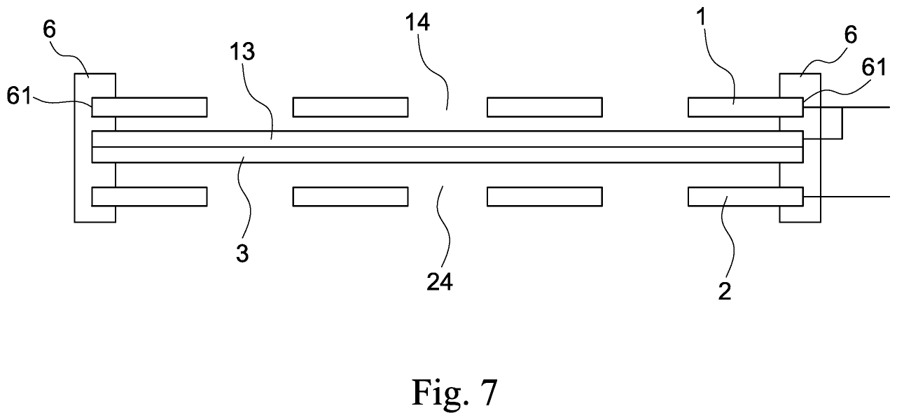

Regarding FIG. 7, which illustrates a schematic cross-sectional view of another embodiment of the multi-layer electrostatic loudspeaker of the present invention. The embodiment includes a first electrode layer 1, a second electrode layer 2, a central dielectric layer 3, and a case 6.

The case 6 accommodates a plurality of pairs of receiving tanks 61, between every pair of the receiving tanks 61 is a gap.

The first electrode layer 1 is disposed in a pair of the receiving tank 61 of the case 6.

The central dielectric layer 3 is disposed in the receiving tank 61 of the case 6, wherein the receiving tank 61 is beneath the first electrode layer 1. A side, close to the first electrode layer 1, of the central dielectric layer 3 is equipped with an auxiliary first electrode layer 13.

The second electrode layer 2 is disposed in the receiving tank 61 that is beneath the central dielectric layer 3.

The first electrode layer 1 and the second electrode layer 2 have a plurality of holes 14, 24.

Through the pairs of receiving tanks 61 of the case 6, the first electrode layer 1, the second electrode layer 2 and the central dielectric layer 3 are disposed therein. The gap between every two receiving tanks 61 is able to avoid the conditions of the first electrode layer 1, the second electrode layer 2 and the central dielectric layer 3 being directly contacted with each other for satisfying Coulomb's law. The first electrode layer 1 and the auxiliary first electrode layer 13 of the central dielectric layer 3 are as one electrode, and the second electrode layer 2 becomes another electrode. When the central dielectric layer 3 is polarized, the vibration effect of the central dielectric layer 3 in the present invention can be increased by converting the electrode polarity through the first electrode layer 1 and the second electrode layer 2. The vibration can then be output through the plurality of holes 14, 24 in the first electrode layer 1 or the second electrode layer 2.

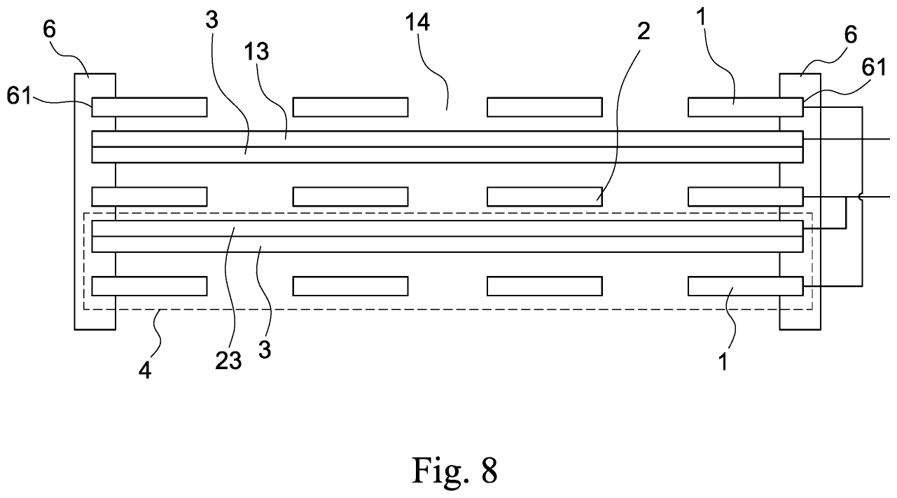

With reference to FIG. 8, which illustrates a schematic cross-sectional view of stacking the first stack structure from the direction of the second electrode layer of another embodiment of the multi-layer electrostatic loudspeaker of the present invention. As for the embodiment, the other first stack structure 4 is further disposed, and is located in the receiving tank 61 of the case 6, wherein the receiving tank 61 is under the second electrode layer 2. The first stack structure 4 has the other auxiliary second electrode layer 23 and the other first electrode layer 1. The auxiliary second electrode layer 23 of the first stack structure 4 is disposed in the receiving tank 61 of the case 6, wherein the receiving tank 6 is beneath the second electrode layer 2. A side, away from the second electrode layer 2, of the auxiliary second electrode layer 23 of the first stack structure 4 is set the other central dielectric layer 3. The first electrode layer 1 of the first stack structure 4 is located in the receiving tank 61 of the case 6, wherein the receiving tank 61 is under the auxiliary second electrode layer 23 of the first stack structure 4.

The embodiment adopts a connection to the first stack structure 4. Equally, by means of the gaps among the receiving tanks 61, the auxiliary second electrode layer 23 of the first stack structure 4 may not be directly contacted with the first electrode layer 1 of the first stack structure 4 for satisfying Coulomb's law. Therefore, the second electrode layer 2 and the auxiliary second electrode layer 23 of the first stack structure 4 are with the same polarity, and so as to the first electrode layer 1, the auxiliary first electrode layer 13 and the first electrode layer 1 of the first stack structure 4. The central dielectric layers 3 are thus polarized, and stacking and connecting with the first stack structure 4 is to let the vibrations of the central dielectric layers 3 be the same, further enhancing the amplification effect.

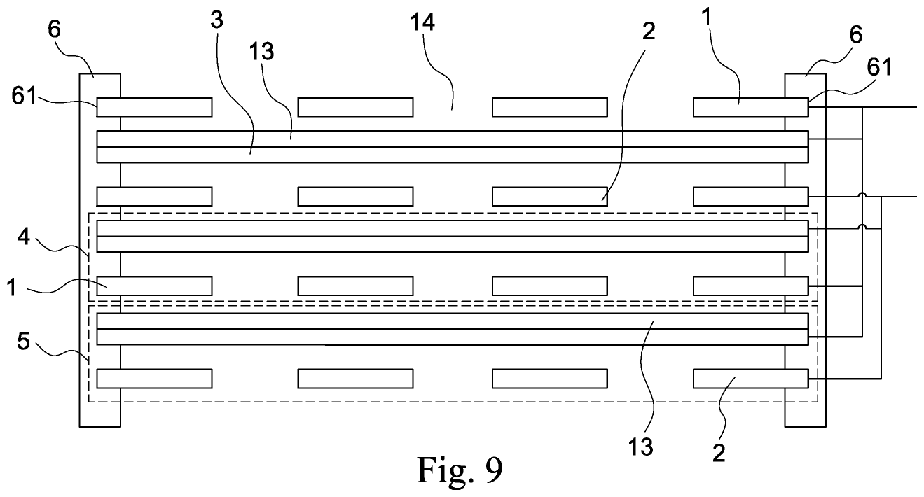

In regard to FIG. 9, which illustrates a schematic cross-sectional view of stacking the second stack structure from the direction of the second electrode layer of another embodiment of the multi-layer electrostatic loudspeaker of the present invention. As for the embodiment, the other second stack structure 5 is further disposed. The second stack structure 5 is located in the receiving tank 61 of the case 6, wherein the receiving tank 61 is under the first stack structure 4. The second stack structure 4 has the other auxiliary first electrode layer 13 and the other second electrode layer 2. The auxiliary first electrode layer 13 of the second stack structure 5 is located in the receiving tank 61 of the case 6, wherein the receiving tank 6 is beneath the first electrode layer 1 of the first stack structure 4. A side, away from the first electrode layer 1 of the first stack structure 4, of the auxiliary first electrode layer 13 of the second stack structure 5 is disposed the other central dielectric layer 3. The second electrode layer 2 of the second stack structure 5 is disposed in the receiving tank 61 of the case 6, wherein the receiving tank 6 is under the auxiliary first electrode layer 13 of the second stack structure 5.

The embodiment is further to connect with the second stack structure 5. Again, a gap between the two receiving tanks 61 in the case 6 is to avoid the condition of the auxiliary first electrode layer 13 of the second stack structure 5 and the second electrode layer 2 of the second stack structure 5 being directly contacted with each other for satisfying Coulomb's law. Hence, the second electrode layer 2, the auxiliary second electrode layer 23 of the first stack structure 4, and the second electrode layer 2 of the second stack structure 5 have the same polarity, and so as to that of the first electrode layer 1, the auxiliary first electrode layer 13, the first electrode layer 1 of the first stack structure 4, and the auxiliary first electrode layer 13 of the second stack structure 5. The central dielectric layers 3 are thus polarized, and the second stack structure 5 stacking and connecting with the first stack structure 4 is to let the vibrations of the central dielectric layers 3 be the same, further enhancing the amplification effect.

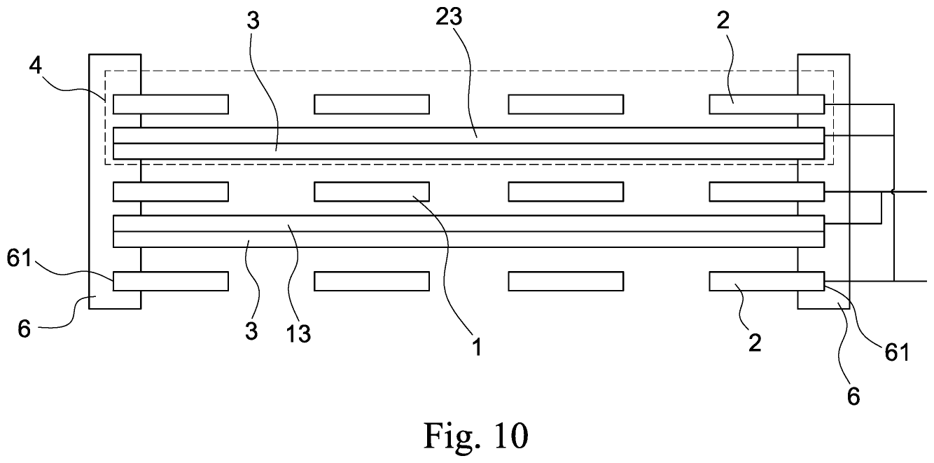

With regard to FIG. 10, which illustrates a schematic cross-sectional view of stacking the first stack structure from the direction of the first electrode layer of another embodiment of the multi-layer electrostatic loudspeaker of the present invention. For the embodiment, the other first stack structure 4 is further disposed. The first stack structure 4 is in the receiving tank 61 of the case 6, wherein the receiving tank 6 is above the first electrode layer 1. The first stack structure 4 has the other auxiliary second electrode layer 23 and the other second electrode layer 2. The auxiliary second electrode layer 23 of the first stack structure 4 is set in the receiving tank 61 of the case 6, wherein the receiving tank 61 is beyond the first electrode layer 1. A side, neighbor to the first electrode layer 1, of the auxiliary second electrode layer 23 of the first stack structure 4 has the other central dielectric layer 3. The second electrode layer 2 of the first stack structure 4 is disposed in the receiving tank 61 of the case 6, wherein the receiving tank 61 is above the auxiliary second electrode layer 23 of the first stack structure 4.

The embodiment adopts a further connection to the first stack structure 4. A gap between the two receiving tanks 61 in the case 6 is to avoid the condition of the auxiliary second electrode layer 23 of the first stack structure 4 and the second electrode layer 2 of the first stack structure 4 being directly contacted with each other for satisfying Coulomb's law. It results that the second electrode layer 2, the auxiliary second electrode layer 23 and the second electrode layer 2 of the first stack structure 4 have the same polarity, and so as to that of the first electrode layer 1 and the auxiliary first electrode layer 13. The central dielectric layers 3 are thus polarized, and stacking and connecting with the first stack structure 4 is to let the vibrations of the central dielectric layers 3 be the same, further enhancing the amplification effect.

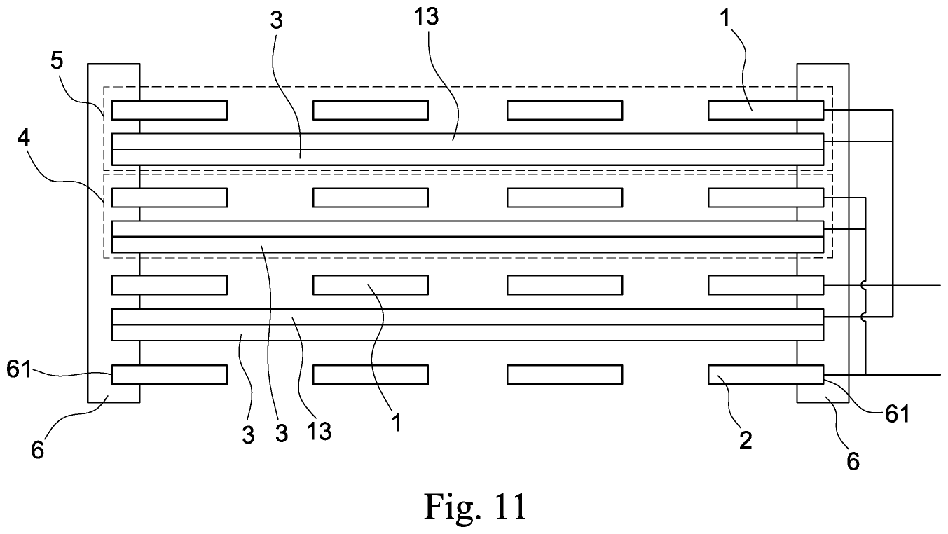

Please refer to FIG. 11, which illustrates a schematic cross-sectional view of stacking the second stack structure from the direction of the first electrode layer of another embodiment of the multi-layer electrostatic loudspeaker of the present invention. Talking to the embodiment, the other second stack structure 5 is further disposed. The second stack structure 5 is set in the receiving tank 61 in the case 6, wherein the receiving tank 61 is beyond the first stack structure 4. The second stack structure 5 has the other auxiliary first electrode layer 13 and the other first electrode layer 1. The auxiliary first electrode layer 13 of the second stack structure 5 is in the receiving tank 61, wherein the receiving tank 61 is above the second electrode layer 2 of the first stack structure 4. A side, close to the second electrode layer 2 of the first stack structure 4, of the auxiliary first electrode layer 13 of the second stack structure 5 has the other central dielectric layer 3, and the auxiliary first electrode layer 13 of the second stack structure 5 is in the receiving tank 61 of the case 6, wherein the receiving tank 61 is above the auxiliary first electrode layer 13 of the second stack structure 5.

The embodiment adopts a further connection to the second stack structure 5. A gap between the two receiving tanks 61 in the case 6 is to avoid the condition of the auxiliary first electrode layer 13 of the second stack structure 5 and the first electrode layer 1 of the second stack structure 5 being directly contacted with each other for satisfying Coulomb's law. It results that the second electrode layer 2, the auxiliary second electrode layer 23 and the second electrode layer 2 of the first stack structure 4 have the same polarity, and so as to that of the first electrode layer 1 and the auxiliary first electrode layer 13, the auxiliary first electrode layer 13 and the first electrode layer 1 of the second stack structure 5. The central dielectric layers 3 are thus polarized, and the second stack structure 5 stacking and connecting with the first stack structure 4 is to let the vibrations of the central dielectric layers 3 be the same, further enhancing the amplification effect.

According to the above-mentioned embodiments, different first stack structures and second stack structures with different directions are used for stacking. By combining a set of first stack structures with a set of second stack structures, unrestricted stacks can be broadly applied. It creates the advantage of the rapid and convenient amplification of vibrations of the central dielectric layer as needed. Thus, the present invention overcomes the stacking issues encountered in practical electrostatic speakers, preventing situations where a lack of potential difference hinders vibration.

Although the present disclosure is disclosed in the foregoing embodiments, it is not intended to limit the present disclosure. Changes and modifications made without departing from the spirit and scope of the present disclosure belong to the scope of the claims of the present disclosure. The scope of protection of the present disclosure should be construed based on the following claims.

What is claimed is:

1. A multi-layer electrostatic loudspeaker comprising:
a first electrode layer (1), a side of the first electrode layer (1) being disposed a first electrode connecting part (12) that is connected with an auxiliary first electrode layer (13), another side of the auxiliary first electrode layer (13) connecting with the first electrode connecting part (12) being disposed a central dielectric layer (3); and
a second electrode layer (2), a side of the second electrode layer (2) being disposed a dielectric layer connecting part (31) that is connected with the central dielectric layer (3).

2. The multi-layer electrostatic loudspeaker according to claim 1 further having a first stack structure (4), a side of the first stack structure (4) being disposed a connecting part that is connected with the second electrode layer (2) or the first electrode layer (1).

3. The multi-layer electrostatic loudspeaker according to claim 2, wherein the connecting part of the first stack structure (4) is connected with the second electrode layer (2), the connecting part of the first stack structure (4) being a second electrode connecting part (22), the second electrode connecting part (22) of the first stack structure (4) being connected with an auxiliary second electrode layer (23), another side of the auxiliary second electrode layer (23) of the first stack structure (4) being disposed the other central dielectric layer (3), the central dielectric layer (3) of the first stack structure (4) being connected with the other first electrode layer (1) of the first stack structure (4) through the other dielectric layer connecting part of the first stack structure (4).

4. The multi-layer electrostatic loudspeaker according to claim 3, wherein the first stack structure (4) is further connected with a second stack structure (5), the second stack structure (5) being connected with the first electrode layer (1) of the first stack structure (4) via the first electrode layer (1) of the first electrode connecting part (12), the first electrode connecting part (12) of the second stack structure (5) being connected with the other auxiliary first electrode layer (13) of the second stack structure (5), another side of the auxiliary first electrode layer (13) of the second stack structure (5) being disposed the other central dielectric layer (3) of the second stack structure (5), the central dielectric layer (3) being connected with the other second electrode layer (2) of the second stack structure (5) via the other dielectric layer connecting part (31) of the second stack structure (5).

5. The multi-layer electrostatic loudspeaker according to claim 2, wherein a connecting part of the first stack structure (4) is connected with the first electrode layer (1), the connecting part of the first stack structure (4) being a dielectric layer connecting part (31), the dielectric layer connecting part (31) of the first stack layer (4) being connected with the other central dielectric layer (3) of the first stack layer (4), another side of the other central dielectric layer (3) of the first stack layer (4) being disposed an auxiliary second electrode layer (23) which belongs to the first stack layer (4), the auxiliary second electrode layer (23) being connected with the other second electrode layer (2) of the first stack structure (4) through the second electrode connecting part (22) of the first stack structure (4).

6. The multi-layer electrostatic loudspeaker according to claim 5, wherein the first stack structure (4) further has a second stack structure (5), which is connected with the second electrode layer (2) of the first stack structure (4) via the other dielectric layer connecting part (31) of the second stack structure (5), the other dielectric layer connecting part (31) of the second stack structure (5) being connected with the other central dielectric layer (3) of the second stack structure (5), another side of the other central dielectric layer (3) being disposed the other auxiliary first electrode layer (13) of the second stack structure (5), the other auxiliary first electrode layer (13) of the second stack structure (5) being connected with the other first electrode layer (1) of the second stack structure (5) via the other first electrode connecting part (12) of the second stack structure (5).

7. A multi-layer electrostatic loudspeaker comprising:
a case (6), accommodating a plurality of pairs of receiving tanks (61), between every pair of the receiving tanks (61) being a gap;
a first electrode layer (1), which is disposed in the receiving tank (61) of the case (6);
an auxiliary first electrode layer (13), which is disposed in the receiving tank (61) of the case (6), wherein the receiving tank (61) is vertically beneath the first electrode layer (1), a side away from the first electrode layer (1) being disposed a central dielectric layer (3); and
a second electrode layer (2), which is disposed in the receiving tank (61) of the case (6), wherein the receiving tank (61) is vertically beneath the first electrode layer (13).

8. The multi-layer electrostatic loudspeaker according to claim 7 further having a first stack structure (4), which is disposed in the pair of receiving tanks (61) of the case (6), wherein the first stack structure (4) is vertically beneath the second electrode layer (2) or vertically beyond the first electrode layer (1).

9. The multi-layer electrostatic loudspeaker according to claim 8, wherein an auxiliary second electrode layer (23) of the first stack structure (4) is connected with a central dielectric layer (3) of the first stack structure (4), the first stack structure (4) being disposed in the receiving tank (61) that is vertically beneath the second electrode layer (23), the central dielectric layer (3) away from the first stack structure (4) being disposed the other first electrode layer (1), wherein the first electrode layer (1) and the auxiliary first electrode layer (13) are connected with the other first electrode layer (1) of the first stack structure (4), and the second electrode layer (2) is connected with the auxiliary second electrode layer (23) of the first stack structure (4).

10. The multi-layer electrostatic loudspeaker according to claim 9, wherein the first stack structure (4) is further connected with a second stack structure (5), which is disposed in the receiving tank (61) vertically beneath the stack structure (4), the other auxiliary first electrode layer (13) of the second stack structure (5) being connected with the other central dielectric layer (3) of the second stack structure (5), a second electrode layer (2) of the second stack structure (5) being away from the other central dielectric layer (3).

11. The multi-layer electrostatic loudspeaker according to claim 8, wherein the first stack structure (4) is disposed in the receiving tank (61) vertically beyond the first electrode layer (1), the other central dielectric layer (3) of the first stack structure (4) being connected with an auxiliary second electrode layer (23) of the first stack structure (4), the second electrode layer (2) of the first stack structure (4) being away from the auxiliary second electrode layer (23) of the first stack structure (4), the first electrode layer (1) being connected with the auxiliary first electrode layer (13), the second electrode layer (2), the other second electrode layer (2) of the first stack structure (4), and the auxiliary second electrode layer (23) of the first stack structure (4) being electrically connected with each other.

12. The multi-layer electrostatic loudspeaker according to claim 11, wherein the first stack structure (4) is further connected with a second stack structure (5), which is disposed in the receiving tank (61) vertically beyond the first stack structure (4), the other dielectric layer (3) of the second stack structure (5) being connected with the other auxiliary first electrode layer (13) of the second stack structure (5), the auxiliary first electrode layer (13) of the second stack structure (5) is away from the first electrode layer (1) of the second stack structure (5), wherein the first electrode layer (1), the auxiliary first electrode layer (13), the other first electrode layer (1) of the second stack structure (5), and the other auxiliary first electrode layer (13) of the second stack structure (5) are electrically connected with each other, the second electric layer (2), the other second electric layer (2) of the first stack structure (4) and the auxiliary second electrode layer (23) of the first stack structure (4) being connected with each other.

13. The multi-layer electrostatic loudspeaker according to claim 1, wherein the first electrode layer (1) or the second electrode layer (2) has a plurality of holes.

14. The multi-layer electrostatic loudspeaker according to claim 7, wherein the first electrode layer (1) or the second electrode layer (2) has a plurality of holes.
